(19) United States
(12) Patent Application Publication
(10) Pub. No.: US 2026/0083226 A1
(43) Pub. Date: Mar. 26, 2026

(54) INDUCTION HEATING

(71) Applicant: Dyson Technology Limited, Malmesbury, Wiltshire (GB)

(72) Inventors: Daniel James Bernard SMITH, Newcastle upon Tyne (GB); Barrie Charles MECROW, Newcastle upon Tyne (GB)

(21) Appl. No.: 19/110,565

(22) PCT Filed: Sep. 13, 2023
(86) PCT No.: PCT/IB2023/059068

§ 371 Date: Mar. 11, 2025

(30) Foreign Application Priority Data
Sep. 15, 2022 (GB) 2213525.5

(51) Int. Cl. A45D 1/04; A45D 1/28; A45D 2/00; H05B 6/10

(52) U.S. Cl. CPC A45D 1/04; A45D 1/28; A45D 2/001; H05B 6/10

(57) ABSTRACT

An induction heating system is provided. The induction heating system includes an induction coil configured to generate a magnetic field and a heating target spaced apart from the induction coil. The heating target is moveable to create a varying distance between the induction coil and the heating target along a length of the heating target to generate a varying amount of heating of the heating target, along the length of the heating target, by penetration of the heating target by the magnetic field generated by the induction coil.

### TECHNICAL FIELD

The present invention relates to induction heating, and in particular to an induction heating system. The invention may find particular use in a haircare appliance, such as a hair straightening or curling device for heating hair.

### BACKGROUND

Induction heating is a process whereby an electrically conducting object is heated by electromagnetic induction in which a varying/alternating magnetic field is produced. The magnetic field penetrates the electrically conductive object, and induces eddy currents within the object. These eddy currents flow through the object and heat the object via Joule heating. In some examples, the object may also be ferromagnetic, such that additional heat is generated by magnetic hysteresis.

### SUMMARY

According to a first aspect of the present invention, there is provided a haircare appliance comprising an induction coil configured to generate a magnetic field and a heating target spaced apart from the induction coil. The heating target is moveable to create a varying distance between the induction coil and the heating target along a length of the heating target so as to generate, in use, a varying amount of heating of the heating target, along the length of the heating target, by penetration of the heating target by the magnetic field generated by the induction coil.

Accordingly, different regions of the heating target can be heated by different amounts depending on their position relative to the induction coil. In some cases, a region of the heating target that is closer to the induction coil is heated to a greater extent than a different region that is further from the induction coil. The inverse may, however, be the case in other examples. In other words, a region of the heating target that is closer to the induction coil is heated to a lesser extent than a different region that is further from the induction coil in these other examples. Nevertheless, in either case, a varying amount of heating is induced along the length of the heating target due to a varying distance between the induction coil and the heating target. Despite different regions of the heating target at different distances from the induction coil being subject to the magnetic field generated by the same induction coil, these regions nevertheless experience different amounts of heating due to a difference in distance between each of these regions and the induction coil. Hence, the magnetic field generated by the induction coil can be used to induce a plurality of different heating zones, at different temperatures, along the length of the heating target. These heating zones are interdependent as they are generated by the magnetic field generated by the same induction coil. Nevertheless, these interdependent heating zones can be generated with a sufficient temperature difference between each other to provide efficient heating in one heating zone, while avoiding overheating in another heating zone.

This arrangement thus allows heating zones to be generated dynamically, merely by changing the distance between a given region of the heating target and the induction coil. In other words, a natural zoning effect can be achieved using the magnetic field generated by induction coil. In this way, heating can be focused in a desired region or regions of the heating target, without unduly heating other regions for which heating is not desired.

The size and number of the heating zones may vary over time, depending on the varying distance between the induction coil and the heating target. This provides for greater flexibility and efficiency in the use of the haircare appliance, as the variation in distance between the heating target and the induction coil along the length of the heating target can also vary over time, e.g. depending on a desired use of the haircare appliance at that time. For example, a user with thin hair may place their hair in contact with a smaller region of the heating target and hence cause a smaller region of the heating target to be moved relative to the induction coil than a user with thick hair. This can cause heating to be concentrated in a smaller region of the heating target for the user with thin hair than for the user with thick hair.

In some examples, the induction coil is a single induction coil configured to heat the heating target. In these examples, the haircare appliance may not include other induction coils for the purpose of induction heating of the heating target. The heating target, which may for example be a heatable plate, may thus be induction heated solely using the single induction coil. An induction heating assembly comprising the single induction coil can be of simpler construction, and may be controlled more straightforwardly. For example, fewer electrical connections can be used to connect a single induction coil to an appropriate control system than would be needed with multiple induction coils. Moreover, using a single induction coil for induction heating of the heating target removes the need to insulate different induction coils from each other, further simplifying the structure and manufacture of the haircare appliance. In addition, the use of a single induction coil provides for more efficient heating of the heating target as a greater proportion of the induction heating assembly can be used for the induction coil itself rather than for electrical connections and/or insulation between a plurality of different induction coils. The single induction coil may be the sole induction coil of the haircare appliance, for example if the haircare appliance is a hair curling device with a single heating target. In other cases, the haircare appliance may include a plurality of heating targets. In such cases, there may be a single induction coil per heating target. For example, if the haircare appliance is a hair straightening device with two opposing arms which can be brought together to trap hair to be heated, there may be a single induction coil per arm, with each induction coil arranged to heat a single heatable plate per arm.

As noted above, with a single induction coil, it is not necessary to leave clearance between circuitry associated with a plurality of different induction coils. This means that the haircare appliance can be safely and efficiently operated using mains power, which typically requires large spacings between various electronic components to reduce the risk of short circuits.

The haircare appliance may comprise a single control circuit to control operation of the single induction coil. The use of a single control circuit for example simplifies control of the heating compared to using a plurality of different control circuits. In addition, manufacture of the haircare appliance is for example more straightforward. The heating of the heating target may also be more efficient as the single control circuit may occupy a smaller area of the induction heating assembly than a plurality of control circuits, meaning that a greater area of the induction heating assembly can be occupied by the induction coil itself. Where the haircare appliance includes a plurality of heating targets with a single induction coil per heating target, the haircare appliance may include a single control circuit per single induction coil, i.e. so the total number of induction coils and control circuits is the same as the total number of heating targets of the haircare appliance. Such a control circuit may for example include a drive circuit to control power flow to the respective induction coil as described further below. There may in some cases also be further circuitry to control the overall power flow to the induction coils.

In some examples, the length of the heating target is greater than a width of the heating target and the induction coil extends along the length of the heating target. In these examples, at least a part of the induction coil is for example elongate along the length of the heating target, and e.g. extends along a majority of a total length of the heating target. In this way, the induction coil can be used to induce heating along the length of the heating target so as to control the amount of heating in an elongate region of the heating target in a straightforward manner.

The induction coil may also extend along the width of the heating target so as to generate, in use, a substantially uniform heating of the heating target along the width of the heating target by the penetration of the heating target by the magnetic field generated by the induction coil, for example if the distance between the induction coil and the heating target along the width of the heating target is substantially uniform (e.g. with a variation in distance of less than 10%). The induction coil extending along the length and width of the heating target for example means that the induction coil can efficiently control heating along both the length and width of the heating target. Substantially uniform heating for example refers to heating that varies by a relatively insignificant amount, such as with a variation of less than 10%. In use, hair may be inserted into the haircare appliance with the width of the heating target (corresponding to the short axis of the heating target) parallel to a length of the hair. In such cases, a substantially uniform heating of the heating target along the width for example means that the length of the hair inserted into the haircare appliance experiences substantially uniform heating. This means that the haircare appliance can heat the hair more efficiently than if the heating varies significantly along the width of the heating target.

In some examples, the induction coil has a winding arrangement comprising a plurality of turns, each turn at a different respective position along an axis parallel to the length of the heating target. For example, the axis may be parallel to a longitudinal axis of an elongate heating target, which may be orthogonal to a direction along which the haircare appliance is intended to move relative to hair to be heated. Such a winding arrangement is for example effective at generating a magnetic field with a strength profile to induce a sufficiently varying amount of heating of the heating target to adequately heat desired regions of the heating target without overheating other regions, based on the proximity of the respective regions of the heating target to the induction coil.

The winding arrangement may be a planar winding arrangement in a plane parallel to a surface of the heating target facing the induction coil. The plane in some examples is a flat plane. A planar winding arrangement can be manufactured straightforwardly. Furthermore, the haircare appliance can be more compact than with non-planar winding arrangements of the induction coil.

The winding arrangement may comprise at least one S-bend. This arrangement for example induces a greater variation in an amount of heating of the heating target as the distance between the heating target and the induction coil varies from a uniform distance than other arrangements. This can improve the efficiency of the haircare appliance, by concentrating a heating effect in a particular region of the heating target without generating hot-spots in other regions of the heating target.

A pitch between neighbouring turns of the plurality of turns may be of the same order of magnitude as a spacing between the induction coil and the heating target with the haircare appliance not in use, with the spacing for example taken between a centroid of the induction coil and an overlapping point on the heating target in a direction parallel to a longitudinal axis of the heating target. Existing induction coils typically have a large pitch between neighbouring coils so as to maximise the reach of the magnetic field generated and to generate a uniform heating effect in a heating target. In contrast, an induction coil in examples herein with a pitch of the same order of magnitude as the spacing between the induction coil and the heating target can give rise to a relatively large variation in the amount of induced heating of the heating target as the heating target moves through a possible range of motion. For example, there can be a variation in heating intensity of up to around 10 times between a region of the heating target at a maximum possible distance from the induction coil and another region of the heating target that is at a minimum possible distance from the induction coil. In this way, an induction coil with this pitch can efficiently heat a given region of the heating target without causing overheating of other regions. The pitch may be less than four times, and in some cases less than two times, the spacing between the induction coil and the heating target with the haircare appliance not in use. This may provide for greater efficiency in induction heating than larger pitches, with particularly effective induction heating of the heating target provided by a pitch of less than two times the spacing.

The winding arrangement may have a varying width along the axis, in a direction perpendicular to the axis. The varying width shapes the magnetic field generated by the induction coil so as to concentrate the heating induced by the magnetic field in a region of the heating target corresponding to a wider portion of the winding arrangement. This for example improves efficiency of the haircare appliance by focusing a heating effect in a particular region of the heating target, such as a region which is expected to be placed adjacent to (or in contact with) hair to be heated. Conversely, a lower amount of heating is for example induced in a region of the heating target corresponding to a narrower portion of the winding arrangement. This can improve safety of the haircare appliance, by using this arrangement to induce a lower amount of heating in a region of the heating target which is not anticipated to be placed adjacent to (or in contact with) hair to be heated, thereby reducing the risk of overheating of this region of the heating target. In some cases, it is anticipated that hair will be placed centrally into the haircare appliance, with a length of the hair lying parallel to a width of the winding arrangement (which is e.g. parallel to a short axis of the heating target). In these cases, a width of a central region of the winding arrangement may be greater than a width of at least one of two peripheral regions of the winding arrangement, where the central portion is between the two peripheral regions. In this way, a corresponding central region of the heating target can be heated to a greater extent than at least one of two peripheral regions of the heating target.

In some examples, the heating target is a flexible plate. This allows a smoothly varying distance between the heating target and the induction coil to be straightforwardly produced, for example by applying pressure to the flexible plate of the heating target. In this way, fine control of the varying distance and the corresponding amount of heating of the heating target can be achieved in a simple manner. Moreover, such a heating target can conform to the object being heated. For example, the heating target can flex or bend due to contact with hair. Conforming to the hair can reduce damage to the hair caused by over compression while also allowing the heat to be distributed more evenly around the hair, as well as gathering the hair in a particular place. This can further improve the efficiency of the heating, as heating can be concentrated where the hair is gathered, due to a greater displacement of the heating target in this region.

In some examples, the heating target is resilient and is biased to be spaced apart from the induction coil. This arrangement is particularly useful if a greater amount of heating occurs with a smaller distance between the induction coil and the heating target. For example, in such cases it means that, in the absence of a further force applied to the heating target (e.g. with the heating target in a default position), the heating target and the induction coil will remain spaced apart from each other so as to avoid overheating of the heating target. This for example increases the safety of the heating appliance by reducing the risk of hot spots occurring when no hair is inserted into the appliance.

In some examples, the heating target is moveable by contact with an entity for heating. For example, the heating target can be moved by contact with hair, when the user places their hair into the haircare appliance. In this way, the heating target can be moved to cause heating of the part of the heating target in contact with the hair without requiring active control of the position of the heating target (or respective parts of the heating target). In other words, the presence of the entity to be heated (such as hair), can indirectly control the heating.

A heating target that is moveable by contact with an entity for heating may be a flexible heating target that bends upon contact with the entity so as to move one part of the heating target relative to another part of the heating target. In other examples, the heating target may include a plurality of components that are moveably coupled together so that respective components can move relative to each upon contact with the entity for heating. For example, the heating target may be articulated or may include a plurality of components embedded within a flexible substrate to permit movement. In cases in which the heating target includes a plurality of moveable components, the components may be rigid or may themselves be flexible. It is to be appreciated that contact of the heating entity by the entity for heating may be indirect contact. In other words, the entity for heating may contact the heating entity via another element, without directly touching the heating entity.

In some examples, the heating target has a thickness of less than around 300 microns. A heating target of this thickness can for example be heated rapidly. The arrangement of the induction coil and the heating target of examples herein reduces the risk of overheating that may otherwise occur with such a thin heating target.

In some examples, the haircare appliance comprises a controller configured to determine a drive frequency to drive the induction coil to generate the magnetic field. In these examples, the controller is configured to determine the drive frequency so as to obtain a first amount of heating of the heating target, at a first portion of the heating target, which is less than a threshold amount of heating. In these examples, a second amount of heating of the heating target, at a second portion of the heating target, is greater than the first amount of heating, the first portion is at a first distance from the induction coil, the second portion is at a second distance from the induction coil, and the first distance is greater than the second distance. The threshold amount of heating is for example a threshold, e.g. corresponding to a threshold temperature, for overheating. In this way, the drive frequency can be determined to avoid a hot spot occurring at the first portion. For example, the first distance may correspond to a maximum possible distance between the induction coil and the heating target, such as the distance between the induction coil and the heating target without an entity to be heated being inserted into the haircare appliance. In this way, the haircare appliance can heat the second portion of the heating target to an appropriate temperature without causing the first portion of the heating target to overheat. This improves the safety of the haircare appliance.

In these examples, the controller may be configured to determine the drive frequency in dependence on at least one of: a measured temperature, a user input, or a measured phase angle between a current supplied to the induction coil and a switching signal associated with driving the induction coil. This provides flexibility for determining the drive frequency so as to obtain a desired heating of the heating target. For example, the temperature of the heating target and/or the environment surrounding the haircare appliance may be measured and the drive frequency may be adjusted accordingly to adjust the amount of heating of the heating target. For example, if the measured temperature of a region of the heating target exceeds a desired or safe operating temperature, the drive frequency can be adjusted to reduce the amount of heating induced in the region of the heating target (e.g. assuming the region of the heating target remains at the same distance with respect to the induction coil). A user may provide a user input, such as by interacting with a user interface such as a button, touch screen, switch etc.), which may e.g. indicate a desired temperature for a region of the heating target to obtain, such as a region of the heating target to be contacted by the hair of the user. The user input may be used on its own or in conjunction with the measured temperature to adjust the drive frequency so as to achieve an appropriate amount of heating to obtain the desired temperature. In further examples, the phase angle between the current supplied to the induction coil and the switching signal associated with driving the induction coil (which for example indicates resonance at that frequency) may also or instead be measured and used to determine the drive frequency, for example to adjust the drive frequency to match a resonant frequency of the induction coil. The phase angle may for example be determined as the phase delay between the rising edge of the switching signal and the zero cross point of the current supplied to the induction coil.

According to a second aspect of the present invention, there is provided an induction heating system comprising an induction coil configured to generate a magnetic field and a heating target spaced apart from the induction coil. The heating target is moveable to create a varying distance between the induction coil and the heating target so as to generate, in use, a varying amount of heating of the heating target, along a length of the heating target, by penetration of the heating target by the magnetic field generated by the induction coil. As explained above with reference to the first aspect of the present invention, this arrangement for example allows interdependent heating zones to be generated dynamically in the heating target in a straightforward, efficient and safe manner. The induction heating system may be used to heat an entity such as a fluid, air, liquid, water or foodstuffs, among other examples. Heat is transferred to the entity via the heating target which may be brought within thermal proximity of the entity. In examples, the heating target is a heating plate or a cooking receptacle, such as a pan.

In some examples of the second aspect of the present invention, the induction coil is a single induction coil configured to heat the heating target. In these examples, the induction heating system may comprise a single control circuit to control operation of the single induction coil. This for example simplifies the construction and operation of the induction heating system. For example, the induction heating of the heating target may be performed solely by the single induction coil. In some cases, the induction heating system may comprise a plurality of heating targets. In these cases, there may be a single induction coil per heating target, to induce heating in the respective heating target that varies along the length of the respective heating target due to a varying distance between the induction coil and the respective heating target. Similarly, there may be a single control circuit per induction coil, so the total number of induction coils and control circuits is the same as the total number of heating targets of the heating system. A control circuit may for example include a drive circuit, described further below.

Further features and advantages will become apparent from the following description of examples in accordance with the invention, which is made with reference to the accompanying drawings.

### BRIEF DESCRIPTION OF THE DRAWINGS

FIGS. 1A and 1B are schematic diagrams of a haircare appliance comprising a flexible heating target, according to an example;

FIGS. 2A and 2B are schematic diagrams of a haircare appliance comprising moveable portions, according to an example;

FIG. 3 is a schematic diagram of an induction coil assembly, according to an example;

FIGS. 4A, 4B and 4C are schematic diagrams of an induction coil with a similar winding arrangement to that shown in FIG. 3 and a flexible heating target, according to an example;

FIG. 5 is a schematic diagram of an induction coil assembly, according to a further example;

FIG. 6 is a schematic diagram illustrating a power distribution of the induction coil assembly of FIG. 5 when in use, according to an example;

FIGS. 7A and 7B are heat maps of the temperature of the surface of a heating target being heated using the induction coil assembly of FIG. 5, according to two different examples;

FIG. 8 is a perspective diagram of a hair straightening appliance, according to an example;

FIG. 9 is a schematic diagram of an induction coil, according to an example; and

FIG. 10 is a schematic diagram of an induction coil, according to a further example.

### DETAILED DESCRIPTION

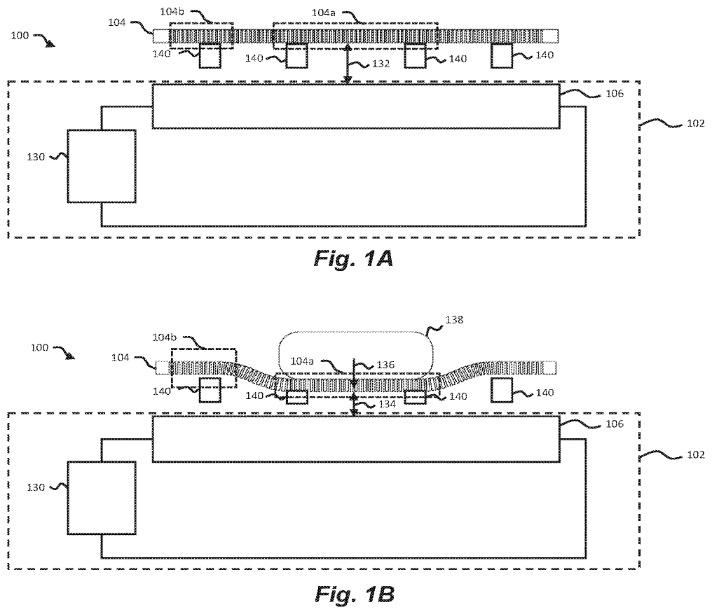

FIGS. 1A and 1B are schematic diagrams of a haircare appliance 100. Haircare appliances are generally used to treat or style hair, and some haircare appliances may treat or style hair using airflow and/or heat. Haircare appliances may be used to treat or style hair in a number of different ways, and some haircare appliances include different attachments to provide different treatment or styling functionality.

In this example, the haircare appliance 100 comprises a single heating target 104, but in other examples may include one or more heating targets. The heating target 104 of this example takes the form of a flexible heating plate. The heating target 104 is moveable and is arranged in a first configuration in FIG. 1A and a second configuration in FIG. 1B.

The haircare appliance 100 includes an induction coil assembly 106 forming part of an induction heating assembly 102. When the induction heating assembly 102 generates or is supplied with a high frequency alternating current, the induction heating assembly 102 generates an alternating/varying magnetic field that penetrates the heating target 104. As mentioned, the magnetic field induces eddy currents within the electrically conductive heating target 104 which causes the heating target 104 to heat up. The heating target 104 in this example is relatively thin, such as less than 300 mm, and hence heats up quickly upon exposure to the magnetic field. In this example, the induction coil assembly 106 comprises an induction coil and the induction coil assembly 106 is supplied with the high frequency current to generate the magnetic field. As will be discussed in more detail below, the induction coil assembly 106 has a top side that faces the heating target 104, and a bottom side that faces away from the heating target 104.

To generate and supply the high frequency current, the induction heating assembly 102 comprises a drive circuit 130. The drive circuit 130 is used to provide and control the current flow through the induction coil assembly 106. The alternating current provided to the induction coil assembly 106 by the drive circuit 130 is at a particular frequency, known as the drive frequency. As will be well understood, an induction coil forms part of an induction system that can be driven to resonance, and the induction system therefore has an associated resonant frequency. The induction system includes the induction heating assembly 102 and at least part of the heating target 104. As will be discussed in more detail below, when the drive frequency matches the resonant frequency of the induction system, the heating target 104 can be heated most effectively. Movement of regions of the heating target 104, relative to the induction heating assembly 102 causes the resonant frequency of the induction system to change. Drive frequencies are typically high, for example around 2 megahertz (MHz) or more.

In this particular example, the heating target 104 is flexible such that a force applied to the heating target 104 causes the heating target 104 to move/flex. In FIG. 1A, the heating target 104 is arranged in a first position and the heating target 104 is substantially flat and unflexed. The heating target 104 is arranged at a first distance 132 away from the induction coil of the induction heating assembly 102. In FIG. 1B, a first region 104a of the heating target 104 is arranged in a second position in which the region has been flexed, bent or otherwise moved towards the induction coil of the induction heating assembly 102. This particular region of the heating target 104 is therefore closer to the induction coil in the second position when compared to the first position, and is arranged at a second distance 134 away from the induction coil. The second distance 134 is smaller than the first distance 132. A second region 104b of the heating target 104 is unflexed and is arranged at the first distance 132. There is hence a varying distance between the heating target 104 and the induction coil, which decreases from the first distance 132 to the second distance 134 and then increases back to the first distance 132 along the length of the heating target 104 in FIG. 1B.

The heating target 104 is bendable along its length from the first position to the second position upon application of a force 136 by an entity 138. In this example, the entity is a volume of hair 138. Upon removal of the hair 138, and therefore the force 136, the heating target 104 is configured to return to the first position depicted in FIG. 1A. One or more biasing members 140, such as springs or resilient members, urge the heating target 104 back towards the first position. The heating target 104 is therefore biased towards the first position, in this example. In this example, the first distance corresponds to a maximum possible distance between the heating target 404 and the induction coil. In FIG. 1B, the force 136 is applied on the first region 104a of the heating target 104 to bend the first region 104a of the heating target 104 towards the induction coil. However, it is to be appreciated that, in other examples, a force may instead be applied to a different region of the heating target to instead bend that region towards the induction coil instead of the first region 104a. A moveable or flexible heating target 104 finds particular use in an induction heating system, in this case a haircare appliance 100, to control the level of heating of the heating target 104.

In this example, the haircare appliance 100 is configured such that when a region of the heating target 104 is arranged in the first position (FIG. 1A), the region is heated to a lower temperature than when the region is arranged in the second position (FIG. 1B). To achieve this, the drive circuit 130 drives the induction coil assembly 106 at a substantially constant drive frequency as the region of the heating target 104 moves between the first and second positions. Due to the varying distance between the induction coil and the heating target 104 along the length of the heating target 104 in FIG. 1B, there is a varying heating of the heating target 104 along the length of the heating target 104.

As mentioned above, the induction system has an associated resonant frequency. FIGS. 1A and 1B show a first region 104a of the heating target 104 and a second region 104b of the heating target 104. As mentioned, the resonant frequency of the induction system depends upon the distance between the regions 104a, 104b of the heating target 104 and the induction heating assembly 102, and in particular the induction coil. Accordingly, when the first region 104a moves relative to the induction coil, the resonant frequency associated with the first region 104a and the induction coil changes. However, because the second region 104b has not moved, or its position has changed very little relative to the induction coil, the resonant frequency associated with the second region 104b and the induction coil remains substantially the same as it was in FIG. 1A.

If the drive frequency of the drive circuit 130 remains constant and is selected to correspond to the resonant frequency associated with the first region 104a and the induction coil with the first region 104a at the second position, the first region 104a will be heated resonantly when it is located in the second position shown in FIG. 1B because the drive frequency substantially matches the resonant frequency of the first region 104a in this position. When the first region 104a is located in the first position shown in FIG. 1A, the resonant frequency no longer matches the drive frequency such that minimal or no heating occurs. Thus, the drive frequency can be selected such that the first region 104a is heated non-resonantly when arranged in the first position and is heated resonantly when arranged in the second position. Thus, the smaller the difference between the drive frequency and the resonant frequency, the greater the region is heated.

Accordingly, the drive frequency may be selected such that the temperature of the heating target 104 at a given location along the length of the heating target 104 is relatively low when that location is in the first position shown in FIG. 1A. The temperature may be below a threshold temperature for example. The temperature may be at a level to avoid serious burns, should a user accidentally touch the heating target 104. The temperature may be at a level to reduce the likelihood of nearby objects being burnt, melted or set on fire, should the device come into contact with the object. For example, the temperature may be below the combustion temperature of common household objects, such as clothing, wood or carpet. The heating target 104 temperature in this unflexed “default” position can be predetermined by a manufacturer by choosing a particular drive frequency.

It will be appreciated that in some instances, as the first region 104a moves, the second region 104b may experience a slight displacement, but the change in resonant frequency associated with the second region 104b may be small or negligible.

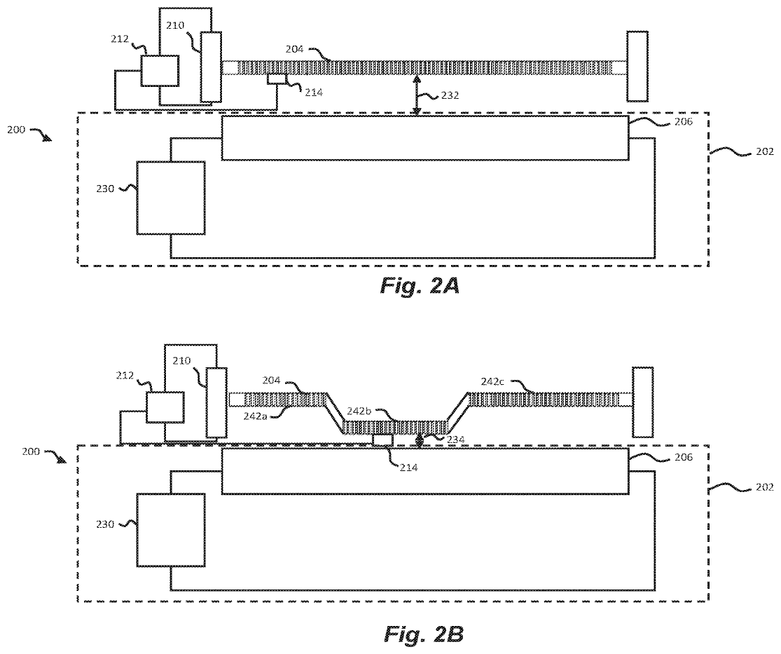

FIGS. 2A and 2B are schematic diagrams of another haircare appliance 200 comprising an induction heating assembly 202 and a heating target 204. In this example (which is a simplified example), the heating target 204 is a single heating target, but in other examples may include one or more heating targets. The heating target 204 of this example takes the form of three interconnected rigid heating plates 242a, 242b, 242c (shown in FIG. 2B), which are moveable relative to each other. In other examples, though, the heating target 204 may include a greater or smaller number of interconnected heating plates and/or the heating plates may be flexible to provide an additional degree of movement. The features and operation of the haircare appliance 200 are the same as the haircare appliance 100, but unlike the heating system 100 of FIGS. 1A and 1B, the heating system 200 of this example further comprises an adjustment assembly 210 that moves the heating plates 242a-242c of the heating target 204 relative to the induction heating assembly 202 and therefore relative to the induction coil of the induction coil assembly 206.

In one example, a controller 212 is configured to control the adjustment assembly 210 and thereby movement of the heating plates 242a-242c of the heating target 204 based on one or more criteria, such as a measured temperature, a user input received by the haircare appliance 200, a measured phase angle between a current supplied to the induction coil and a switching signal associated with driving the induction coil, a time and/or power supply constraints. For example, FIGS. 2A and 2B depict a temperature sensor 214 to measure the temperature of the heating target 204 and based on the measured temperature, the controller 212 can adjust the position of the heating plates 242a-242c.

FIG. 2A shows the heating target 204 arranged in a first position. In FIG. 2A, the entire heating target 204 is arranged at a first distance 232 away from the induction heating assembly 202. In FIG. 2B, the second heating plate 242b has been moved towards the induction heating assembly 202 and is arranged in a second position at a second distance 234 away from the induction heating assembly 202. The first and third heating plates 242a, 242c are still at the first distance 232 in FIG. 2B. The first distance 232 is greater than the second distance 234. There is therefore a varying distance between the heating target 204 and the induction coil of the induction heating assembly 202 in FIG. 2B.

Accordingly, in the same way as described above for the haircare appliance 100, the heating target 204 is moveable to create a varying distance relative to the induction coil, so that there is a varying level of heating along the length of the heating target 204. In this example, the adjustment assembly 210 is configured to move one or more heating plates of the heating target 204 from the first position (shown in FIG. 2A) to the second position (shown in FIG. 2B) so as to heat the heating plate or plates at the second position to a higher temperate than the heating plate or plates at the first position.

In the examples of FIGS. 1A, 1B, 2A and 2B discussed above, the drive frequency may remain the same throughout the heating session (i.e. as the heating target 104, 204 moves/flexes). As mentioned, the resonant frequency of an induction system changes as the heating target 104, 204 moves and may get closer or further away from the drive frequency. This provides a simple way of controlling the level of heating, but assumes that the heating target 104, 204 will move to the desired location each time, which may not always be the case, especially when the movement is being controlled by contact with an entity. For example, in some circumstances, the heating target 104 may not fully flex so the distance 134 upon contact with the entity is less than is needed to ensure resonant heating. This would mean that the resonant frequency would not match the drive frequency and so the heating target would be heated less efficiently.

To overcome this, the drive frequency can be adjusted or “tuned” as the heating target 104, 204 moves to ensure that it matches the resonant frequency more closely. The drive frequency can therefore be selected based on the position of the heating target 104, 204 (or based on the position of a region of the heating target 104, 204) relative to the induction coil of the induction heating assembly 102, 202 as the haircare appliance 100, 200 is used.

To achieve resonant heating of the heating target 104, 204 or a particular region of the heating target 104, 204, the drive frequency would need to match the resonant frequency, but because the resonant frequency depends on the position of the heating target 104, 204, it would need to be determined for each position.

In some examples, the resonant frequency at a particular position and moment in time can be determined/calculated by measuring the current and/or voltage at certain locations within the circuit and inputting these parameters into well known, standard equations. Once the resonant frequency is known, the drive circuit 130, 230 can adjust the drive frequency to match the determined resonant frequency. If the position of the heating target 104, 204 moves again, the same process can be repeated so that the drive frequency is adjusted as the heating target 104, 204 moves. A controller can determine the resonant frequency and therefore the drive frequency and responsively cause the induction heating assembly 102, 202 to operate at the selected drive frequency.

Alternatively, rather than determining the resonant frequency through measurement of the circuit parameters, the resonant frequency may be obtained from a lookup table based on a measured position of the heating target 104, 204 (or a region of the heating target 104, 204) being heated. For example, one or more light sensors (not shown) may measure the distance 134, 234 between the induction heating assembly 102, 202 and a region of the heating target 104, 204 to be heated to a higher temperature than a different region of the heating target 104, 204. Based on a previous calibration or calculation, specific measured distances may correspond to specific resonant frequencies and therefore specific drive frequencies. A lookup table stored in memory of a controller may store an association between the measured distances and the resonant frequencies and/or drive frequencies, so that the desired drive frequency can be selected to resonantly heat that region of the heating target 104, 204, e.g. without causing overheating of a different region of the heating target 104, 204 such as a region at a maximum possible distance from the induction coil. If the position of the heating target 104, 204 moves again, the same process can be repeated so that the drive frequency is adjusted as the heating target 104, 204 moves. A controller can determine the resonant frequency and therefore the drive frequency and responsively cause the induction heating assembly 102, 202 to operate at the selected drive frequency.

Accordingly, the systems 100, 200 of FIGS. 1A, 1B, 2A and 2B may be controlled via either method.

FIGS. 1A, 1B, 2A and 2B show haircare appliances 100, 200 in side view. In these examples, the induction coil of the induction coil assembly 106, 206 extends along the length of the heating target 104, 204 so that the heating generated along the length of the heating target 104, 204 can be controlled by the magnetic field generated by the induction coil. In plan view, the induction coil of these haircare appliances 100, 200 also extends along the width of the heating target 104, 204 so that a magnetic field can be generated by the induction coil along the width of the heating target 104, 204 so as to control heating of the heating target 104, 204 along its width. In these examples, the distance between the heating target 104, 204 and the induction coil is uniform along the width of the heating target 104, 204. The uniform separation between the heating target 104, 204 and the induction coil causes uniform heating of the heating target 104, 204 along its width. It is to be appreciated, though, that in some cases the separation (and hence the heating) may not be exactly uniform along the width of the heating target 104, 204 but may instead vary within acceptable operational tolerances. Moreover, this is merely an example, and in other cases, the induction coil need not extend along the length and/or width of the heating target, e.g. if only a portion of the heating target is to be heated to an appreciable degree.

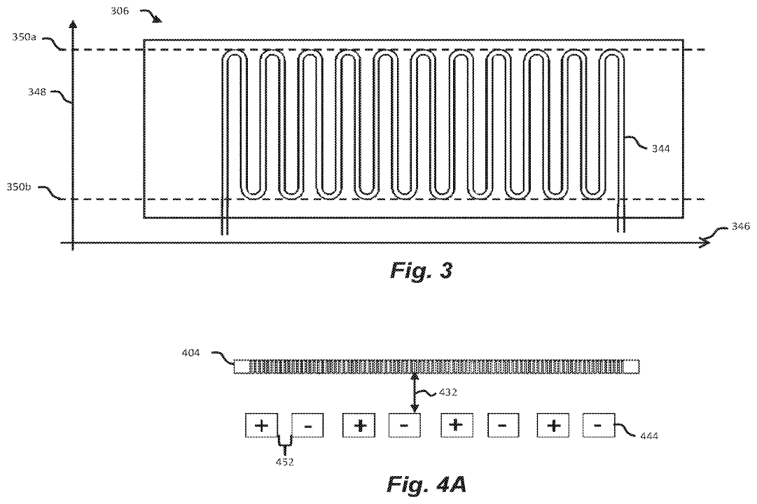

FIG. 3 is a schematic diagram of an induction coil assembly 306, which can be used for example as the induction coil assembly 106, 206 of examples in accordance with FIGS. 1A, 1B, 2A and 2B. The induction coil assembly 306 includes a single induction coil 344, which can for example be controlled with a single control circuit. The induction coil 344 has a winding arrangement including a plurality of turns. Each turn in FIG. 3 lies in the same plane and is located at a different respective position along the length of the induction coil assembly 306. In other words, each turn is at a different location along an axis 346 parallel to the length of the induction coil assembly 306. In this case, the induction coil assembly 306 is arranged to be positioned facing a heating target, such as the heating targets 104, 204 of FIGS. 1A, 1B, 2A and 2B, similarly to the induction coil assemblies 106, 206 of FIGS. 1A, 1B, 2A and 2B. With this arrangement, the surface of the induction coil assembly 306 shown in plan view in FIG. 3 lies in a plane parallel to a surface of the heating target 104, 204 facing the induction coil assembly 306, and the axis 346 parallel to the length of the induction coil assembly 306 is also parallel to the length of the heating target 104, 204.

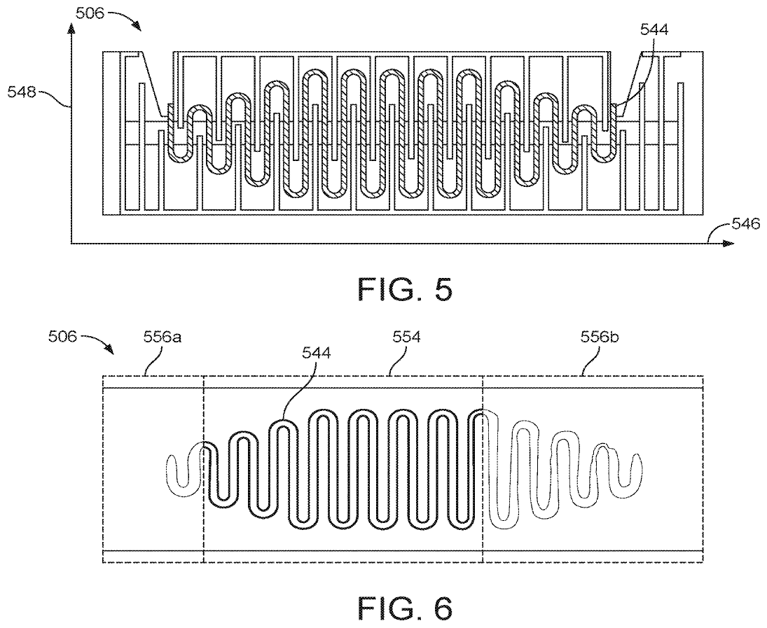

Neighbouring turns are located at opposite sides of a width of the induction coil assembly 306. In this example, odd number turns (i.e. first, third, fifth etc. turns) are located at a first position 350a along an axis 348 parallel to a width of the induction coil assembly 306 (which in this case is parallel to a width of a heating target with the induction coil assembly arranged in a haircare appliance). Even number turns (i.e. second, fourth sixth etc. turns) are located at a second position 350b along the axis 348, which differs from the first position 350a. This winding arrangement gives rise to a plurality of S-bends in the plane of the induction coil assembly 306. In other words, the winding arrangement has a wave shape in the plane of the induction coil assembly 306. In this example, an envelope of the wave shape of the winding arrangement has a uniform width along the length of the induction coil assembly 306. In other examples, though, such as that of FIGS. 5 and 6 (discussed further below), this need not be the case.

A winding arrangement such as that shown in FIG. 3 induces a relatively large variation in the amount of heating induced in the heating target with a varying distance between the induction coil and the heating target. This effect causes a large variation in heating as a region of the heating target moves from a maximum to a minimum distance from the induction coil. A single induction coil can therefore passively moderate heat generation onto a region of the heating target that is closer to the induction coil than another region (e.g. a region of heating target that is bent towards the induction coil by the presence of hair), while avoiding hotspots.

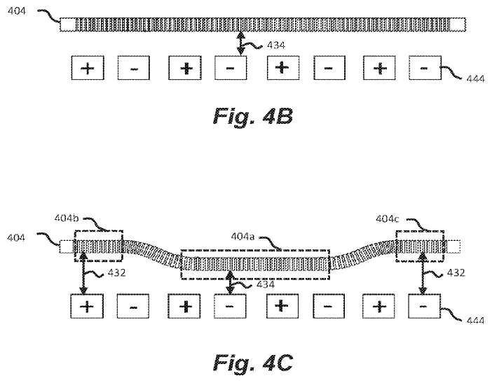

FIGS. 4A, 4B and 4C are side views showing a flexible heating target 404, which is similar to the heating target 104 of FIGS. 1A and 1B, and an induction coil 444 with a series of S-bends. The induction coil 444 of FIGS. 4A, 4B and 4C is the same as the induction coil 344 of FIG. 3 but has fewer turns for ease of illustration. In FIG. 4A, there is a first distance 432 between the heating target 404 and the induction coil 444, in FIG. 4B there is a second distance 434 between the heating target 404 and the induction coil 444, and in FIG. 4C there is a second distance 434 between a first region 404a of the heating target 404 and the induction coil 444 and a first distance 432 between second and third regions 404b, 404c of the heating target 404 and the induction coil 444. The second distance 434 is less than the first distance 432.

In FIG. 4A, with a current of 10 A flowing through the induction coil 444 and a first distance 432 of 1 mm between the induction coil 444 and the heating target 404, 20 W of heating of the heating target 404 is obtained. This corresponds to a low heating load.

In contrast, with the entire heating target 404 at a maximum deflection as shown in FIG. 4B, a greater amount of heating is obtained. In FIG. 4B, with a current of 10 A flowing through the induction coil 444 and a second distance 434 of 0.2 mm between the induction coil 444 and the heating target 404, 155 W of heating of the heating target 404 is obtained.

Finally, in FIG. 4C, with a current of 10 A flowing through the induction coil 444, the first region 404a (which is at the second distance 434 of 0.2 mm) experiences 142 W of heating. The second and third regions 404b, 404c (which are each at the first distance 432 of 1 mm) each experience 6.5 W of heating. The first region 404a is between the second and third regions 404b, 404c. There is thus higher heating where the spacing between the induction coil 444 and heating target 404 is smaller. This allows an induction heating system such as a haircare appliance including the arrangement shown in FIGS. 4A-4C to effectively heat one region of a heating target using a single induction coil, without causing overheating in other regions.

The first, second and third regions 404a-404c of FIG. 4C for example correspond to dynamically generated heating zones, each generated by the same induction coil 444. The amount of heating in each heating zone differs from each adjacent heating zone but is nevertheless interdependent as it is induced by the same induction coil 444. Different heating zones can be straightforwardly generated by displacing different respective regions of the heating target 404 towards the induction coil 444. The heating zones are not fixed: they can be easily varied over time merely by controlling the variation in distance between the heating target 404 and the induction coil 444.

In the example of FIGS. 4A-4C, the pitch 452 between neighbouring coils of the induction coil 444 is relatively small. The pitch 452, which is indicated in FIG. 4A as the distance between neighbouring coils in a plane of the induction coil 444 (which in this example is parallel to a plane of the heating target 404 when not deflected), is of the same order of magnitude as the maximum spacing between the induction coil 444 and the heating target 404 in this example. In some examples, suitable pitches range from around 1 mm to 2 mm up to around 5 mm or 6 mm, and in some cases up to around 10 mm, for a spacing between the induction coil 444 and the heating target 404 of around 1 mm.

FIG. 5 is a schematic diagram of an induction coil assembly 506, according to another example. The induction coil assembly 506 of FIG. 5 includes a single induction coil 544 and is similar to the induction coil assembly 306 of FIG. 3. However, whereas the winding arrangement of the induction coil 344 of FIG. 3 has a uniform width (which is the distance between the first and second positions 350a, 350b along the axis 348 in FIG. 3), the winding arrangement of the induction coil 544 of FIG. 5 has a non-uniform width along an axis 548 parallel to a width of the induction coil assembly 506 (which in this case is also parallel to a width of the heating target to be used with the induction coil assembly). The winding arrangement of the induction coil 544 of FIG. 5 is otherwise the same as that shown in FIG. 3, and includes a series of S-bends along an axis 546 parallel to a length of the induction coil assembly 506 (which in this case is also parallel to a length of the heating target to be used with the induction coil assembly).

In FIG. 5, it is anticipated that the user of a haircare appliance including the induction coil assembly 506 and the heating target will typically place their hair around the middle of the haircare appliance (along the length of the haircare appliance). In use, the hair will apply a force to the central region of the heating target, causing greater deflection of the heating target towards the induction coil 544 at the middle of the heating target than at the ends (along the length of the heating target). In view of this, the induction coil 544 of FIG. 5 is narrower at each end and wider in the middle along the axis 546 parallel to the length of the induction coil assembly 506. The induction coil 544 hence has a tapered wave shape so as to concentrate power in the middle of the heating target to be heated, which corresponds to an area at which a maximum deflection of the heating target towards the induction coil 544 is expected. An envelope of the wave shape of the winding arrangement of the induction coil 544 of FIG. 5 hence has a varying width along the length of the induction coil assembly 506. In this example, the envelope is narrower at the ends than in the middle. However, in other examples, an envelope of a wave-shaped winding arrangement may have a different width profile. For example, an envelope may be wider in a different location along the length of the induction coil assembly 506, which nevertheless corresponds with a position along the length of a heating target that is to be heated to a greater extent than another position.

FIG. 6 is a schematic diagram illustrating a power distribution of the induction coil assembly 506 of FIG. 5 when in use. In FIG. 6, hair is inserted into the hair appliance comprising the induction coil assembly 506 so as to displace a first region of the heating target towards the induction coil 544 to a greater extent than second and third regions of the heating target that surround the first region. This creates a hair loading zone 554 of the induction coil assembly 506 corresponding to the first region of the heating target, for which greater heating is desired to heat the hair. The hair loading zone 554 includes a portion of the induction coil 544 with a wider envelope than non-hair-loading zones 556a, 556b located on either side of the hair loading zone 554.

As the distance between the induction coil 544 and the heating target is smaller and the envelope of the induction coil 544 is wider in the hair loading zone 554 than in the non-hair-loading zones 556a, 556b, a higher proportion of power is concentrated in the first region of the heating target corresponding to the hair loading zone 554 than in the second and third regions of the heating target corresponding to the non-hair-loading zones 556a, 556b. In the example of FIGS. 6, 92% of the power is concentrated in the first region of the heating target, 1% of the power is in the second region of the heating target (corresponding to a first non-hair-loading zone 556a) and 7% of the power is in the third region of the heating target (corresponding to a second non-hair-loading zone 556b). This causes greater heating of the first region of the heating target than the second and third regions.

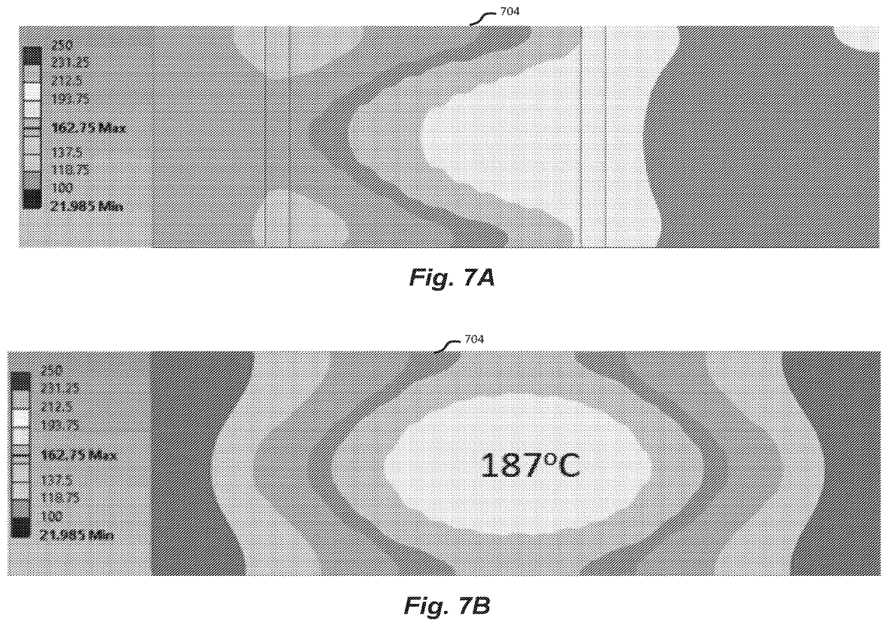

FIGS. 7A and 7B are heat maps of the temperature of the surface of a heating target 704 being heated using the induction coil assembly 506 of FIG. 5, according to two different examples. In this example, the heating target 704 is a flexible heating plate, like the heating target 104 of FIGS. 1A and 1B. The power used in these examples is 330 W.

In FIG. 7A, an end region of the heating target 704 is flexed towards the induction coil of the induction coil assembly 506 and is at the second distance 134 from the induction coil (shown in FIG. 1B). The remainder of the heating target 704 is biased to remain at the first distance 132 from the induction coil (where the first distance 132 is shown in FIG. 1A). The temperature of the heating target 704 is therefore higher at the end region (to the right hand side of FIG. 7A) due to the smaller distance between the heating target 704 and the induction coil than in the remainder of the heating target 704. In this example, the user is moving their hair slowly through the haircare appliance. This means that the end region of the heating target 704 is heated for longer than with a faster user. However, as heating is concentrated in the end region of the heating target 704, this part of the heating target 704 is heated effectively without overheating the remainder of the heating target.

In FIG. 7B, a central region of the heating target 704 is flexed towards the induction coil so that the central region is at the second distance 134 from the induction coil. The outer regions of the heating target 704 are unflexed and are hence at the first distance 132 from the induction coil. Due to the tapered wave shape of the induction coil, and the smaller distance between the central region of the heating target 704 and the induction coil, the central region of the heating target 704 is heated to a higher temperature than the outer regions. There is a greater difference in temperature between the hottest and coldest parts of the heating target 704 in FIG. 7B than in FIG. 7A as, in FIG. 7B, the widest part of the winding arrangement of the induction coil corresponds to the portion of the heating target 704 that is deflected towards the induction coil due to contact with the hair, concentrating power in this region. The heating is therefore concentrated in the deflected region of the heating target to a greater extent in FIG. 7B than in FIG. 7A, in which the deflected region of the heating target corresponds to a narrower part of the winding arrangement of the induction coil.

The heat maps shown in FIGS. 7A and 7B compare well to those obtained using a known 6 zone resistive heater. In particular, the heat maps shown in FIGS. 7A and 7B pass the same “hot spot” criterion as those obtained using the 6 zone resistive heater, as hot spots are absent in the heat maps of FIGS. 7A and 7B. Moreover, the example induction heating arrangements herein (which can for example be used in a haircare appliance) can deliver the same heating power as the 6 zone resistive heater but with a more even heat spread. Furthermore, the arrangements herein allow for rapid heat-up and cool down, adaptive heating target temperatures and low waste heat levels, which cannot be achieved by resistive heaters that typically require bulky heat spreaders to avoid hot spots.

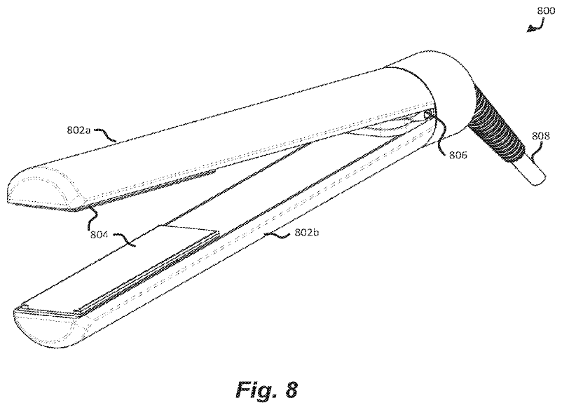

FIG. 8 is a perspective view of an example hair straightening appliance 800 comprising a first arm 802a and a second arm 802b, which are joined together at one end by a hinge 806. A power supply cable 808 extends away from the hinged end of the hair straightening appliance 800. In other examples, the hair straightening appliance 800 comprises an internal battery power source, such that the power supply cable 808 is omitted.

Each arm 802a, 802b comprises a heating target 804 located towards the end of the arm furthest away from the hinge 806. Inside each arm is an induction heating assembly to heat the heating target 804. Any of the induction heating assemblies described herein may be used as the induction heating assembly to heat the heating target 804. FIG. 8 shows the hair straightening device 800 in an open position where the heating targets 804 are spaced apart. The heating targets 804 are arranged to contact each other when the first and second arms 802a, 802b are brought together by a user into a closed position. The heating targets 804 comprise a hair contacting surface which contacts hair, in use. Hair that is to be straightened is trapped between the two heating targets 804 and heat is transferred to the hair from the heating targets 804.

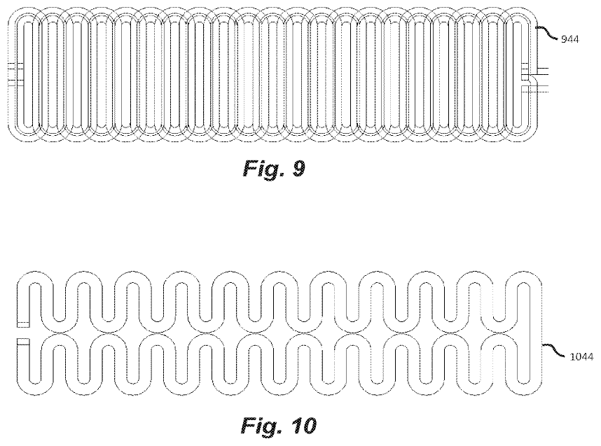

There are many suitable winding arrangements which may be used for an induction coil in accordance with the examples herein. For example, various planar winding arrangements in which the induction coil is wound within a plane, such as a flat plane, are suitable. Further examples of induction coils that can be used as the induction coil in any of the examples herein are shown schematically in plan view in FIGS. 9 and 10.

The induction coil 944 of FIG. 9 is a single induction coil with a multi-layer wave winding arrangement. Similarly to the induction coil 344 of FIG. 3, the induction coil 944 of FIG. 9 has a plurality of S-bends, but with a more complex, multi-layer, arrangement. In contrast, the S-bends of the induction coil 344 of FIG. 3 are arranged in a single layer.

The induction coil 1044 of FIG. 10 is also a single induction coil, but is a single layer closed loop induction coil. The winding arrangement of the induction coil 1044 of FIG. 10 is similar to that of the induction coil 344 shown in FIG. 3, except that the induction coil 1044 of FIG. 10 has two rows of S-bend turns which lie next to each other in a plane of the induction coil 1044, rather than having a single row of S-bend turns as in the induction coil 344 of FIG. 3. In further examples, an induction coil may have a similar winding arrangement to that shown in FIG. 10 but with at least one more row of S-bend turns in a plane of the induction coil.

The above examples are to be understood as illustrative examples. Further examples are envisaged. Although the examples above relate to haircare appliances, the principles described herein can be used in other induction heating systems, for heating other materials than hair.

In some examples, an induction coil assembly according to examples herein is arranged to generate an asymmetric magnetic field such that the magnetic field strength at a top side of the induction coil assembly facing towards the heating target is substantially greater than the magnetic field strength at a bottom side of the induction coil assembly facing away from the heating target. For example, a ratio of the magnetic field strength at the top side to the magnetic field strength at the bottom side may be greater than about 100 or greater than about 1000. Thus, a high proportion of the magnetic energy is directed towards the heating target assembly. This asymmetric, or single-sided, magnetic field therefore provides a more energy efficient heating process by reducing the amount magnetic energy being lost in other directions.

To obtain an asymmetric magnetic field, the induction coil assembly may include a ferrite screen to prevent the magnetic field generated by the induction coil of the induction coil assembly from substantially penetrating beyond the bottom side of the induction coil assembly. In other examples, to achieve the asymmetric magnetic field, the induction coil assembly comprises a power coil layer (corresponding to the induction coil described herein) and a screening coil layer. In general terms, the power coil layer is designed to generate a sufficiently strong magnetic field to heat the heating target assembly and the screening coil layer is designed to generate an opposing magnetic field to cancel out or sufficiently reduce the magnetic flux passing out of the bottom side of the induction coil assembly. At any point along the induction coil assembly, the current passing through the conductor windings in the screening coil layer is opposite to the current passing through the conductor windings in the power coil layer. The current flowing in the opposite direction in the screening coil layer creates an opposing magnetic field.

Any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A haircare appliance comprising:
an induction coil configured to generate a magnetic field; and
a heating target spaced apart from the induction coil,
wherein the heating target is moveable to create a varying distance between the induction coil and the heating target along a length of the heating target so as to generate, in use, a varying amount of heating of the heating target, along the length of the heating target, by penetration of the heating target by the magnetic field generated by the induction coil.

2. The haircare appliance of claim 1, wherein the induction coil is a single induction coil configured to heat the heating target.

3. The haircare appliance of claim 2, wherein the haircare appliance comprises a single control circuit to control operation of the single induction coil.

4. The haircare appliance of claim 1, wherein the length of the heating target is greater than a width of the heating target and the induction coil extends along the length of the heating target.

5. The haircare appliance of claim 4, wherein the induction coil extends along the width of the heating target so as to generate, in use, a substantially uniform heating of the heating target along the width of the heating target by the penetration of the heating target by the magnetic field generated by the induction coil.

6. The haircare appliance of claim 1, wherein the induction coil has a winding arrangement comprising a plurality of turns, each turn at a different respective position along an axis parallel to the length of the heating target.

7. The haircare appliance of claim 6, wherein the winding arrangement is a planar winding arrangement in a plane parallel to a surface of the heating target facing the induction coil.

8. The haircare appliance of claim 6, wherein the winding arrangement comprises at least one S-bend.

9. The haircare appliance of claim 6, wherein a pitch between neighbouring turns of the plurality of turns is of the same order of magnitude as a spacing between the induction coil and the heating target with the haircare appliance not in use.

10. The haircare appliance of claim 6, wherein the winding arrangement has a varying width along the axis, in a direction perpendicular to the axis.

11. The haircare appliance of claim 10, wherein a width of a central region of the winding arrangement is greater than a width of at least one of two peripheral regions of the winding arrangement, wherein the central region is between the two peripheral regions.

12. The haircare appliance of claim 1, wherein the heating target is a flexible plate.

13. The haircare appliance of claim 1, wherein the heating target is resilient and is biased to be spaced apart from the induction coil.

14. The haircare appliance of claim 1, wherein the heating target is moveable by contact with an entity for heating.

15. The haircare appliance of claim 1, wherein the heating target has a thickness of less than around 300 microns.

16. The haircare appliance of claim 1, further comprising a controller configured to determine a drive frequency to drive the induction coil to generate the magnetic field,
wherein the controller is configured to determine the drive frequency so as to obtain a first amount of heating of the heating target, at a first portion of the heating target, which is less than a threshold amount of heating,
wherein a second amount of heating of the heating target, at a second portion of the heating target, is greater than the first amount of heating, the first portion is at a first distance from the induction coil, the second portion is at a second distance from the induction coil, and the first distance is greater than the second distance.

17. The haircare appliance of claim 16, wherein the first distance corresponds to a maximum possible distance between the induction coil and the heating target.

18. The haircare appliance of claim 16, wherein the controller is configured to determine the drive frequency in dependence on at least one of: a measured temperature, a user input, or a measured phase angle between a current supplied to the induction coil and a switching signal associated with driving the induction coil.

19. An induction heating system comprising:
an induction coil configured to generate a magnetic field; and
a heating target spaced apart from the induction coil,
wherein the heating target is moveable to create a varying distance between the induction coil and the heating target along a length of the heating target so as to generate, in use, a varying amount of heating of the heating target, along the length of the heating target, by penetration of the heating target by the magnetic field generated by the induction coil.

20. The induction heating system of claim 19, wherein the induction coil is a single induction coil configured to heat the heating target and the induction heating system comprises a single control circuit to control operation of the single induction coil.
